(19) United States
(12) Patent Application Publication
(10) Pub. No.: US 2026/0149128 A1
(43) Pub. Date: May 28, 2026

(54) APPARATUS AND METHOD FOR MANUFACTURING SECONDARY BATTERY

(71) Applicant: Samsung SDI Co., Ltd., Yongin-si (KR)

(72) Inventors: Chanwoong Park, Yongin-si (KR); Sungho Lee, Yongin-si (KR)

(73) Assignee: Samsung SDI Co., Ltd., Yongin-si (KR)

(21) Appl. No.: 19/369,886

(22) Filed: Oct. 27, 2025

(30) Foreign Application Priority Data
Nov. 22, 2024 (KR) 10-2024-0168796

(51) Int. Cl. H01M 50/516; H01M 10/04; H01M 50/538; H01M 50/564

(52) U.S. Cl. CPC H01M 50/516; H01M 10/0404; H01M 50/538; H01M 50/564; H01M 2220/20

(57) ABSTRACT

The present disclosure provides an apparatus and method for manufacturing a secondary battery, in which it is possible to minimize damage to a separator and increase welding strength by maintaining a safety distance between a stack of an electrode assembly and a current collector and also securing good adhesion between an electrode tab and a current collector when the current collector is welded to the electrode assembly. The apparatus for manufacturing a secondary battery includes a side pusher disposed to correspond to an electrode assembly having an electrode tab and formed to move and press a sub-tab, which will be welded to the electrode tab, toward the electrode tab through linear movement, a first driving module that allows the side pusher to linearly reciprocate, a support jig installed so that a position thereof is adjustable between the electrode assembly and the side pusher, and a second driving module configured to stop movement of the support jig while the sub-tab is in contact with the electrode tab and allow the support jig to block a pressing force of the side pusher from being further transmitted to the electrode tab.

### CROSS-REFERENCE TO RELATED APPLICATIONS

This present application claims priority to and the benefit under 35 U.S.C. § 119(a)-(d) of Korean Patent Application No. 10-2024-0168796, filed on Nov. 22, 2024, in the Korean Intellectual Property Office, the entire disclosure of which is incorporated herein by reference.

### FIELD

The present disclosure relates to a secondary battery, and more specifically, to an apparatus and method for manufacturing a secondary battery, and the method includes a welding process.

### BACKGROUND

Secondary batteries are batteries that can be charged and discharged, unlike primary batteries that cannot be charged. A secondary battery mainly includes an electrode assembly composed of a positive electrode plate, a separator, and a negative electrode plate, a can (or case) that accommodates the electrode assembly, and an external terminal for connecting the electrode assembly to an external power source and load.

Positive electrode and negative electrode tabs are formed on the electrode assembly, and the electrode tabs or related members (e.g., a current collector, a connection member, and an auxiliary ta) are electrically connected to positive and negative electrode terminals or related members (e.g., a rivet terminal, a cap plate, a rivet terminal, and the like), which are disposed at the outside.

The herein information disclosed in this Background section is for enhancement of understanding of the background of the present disclosure, and therefore, it may contain information that does not constitute a related (or prior) art.

### SUMMARY

The present disclosure is directed to providing an apparatus and method for manufacturing a secondary battery, which allow damage to a separator to be minimized and welding strength to be increased when a current collector is welded to an electrode assembly.

According to aspects of the present disclosure, there is provided an apparatus for manufacturing a secondary battery, which includes a side pusher disposed to correspond to an electrode assembly having an electrode tab and formed to move and press a sub-tab, to be welded to the electrode tab, toward the electrode tab through linear movement, a first driving module that allows the side pusher to linearly reciprocate, a support jig installed so that a position thereof is adjustable between the electrode assembly and the side pusher, and a second driving module configured to stop movement of the support jig while the sub-tab is in contact with the electrode tab and allow the support jig to block a pressing force of the side pusher from being further transmitted to the electrode tab.

According to aspects of the present disclosure, there is provided an apparatus of manufacturing a secondary battery, which includes a support unit formed to support an electrode assembly, having an electrode tab, to be substantially horizontal and provide a guide body, a reciprocation carrier supported by the guide body to reciprocate in a horizontal state by an external force, a side pusher fixed to the reciprocation carrier and formed to move and support a sub-tab input from an outside of the secondary battery toward the electrode tab by linear motion of the reciprocation carrier, a support jig positioned between the electrode assembly and the side pusher while supported by the reciprocation carrier, and an elastic support part that elastically supports the reciprocation carrier and allows the side pusher to elastically press the sub-tab toward the electrode tab with the support jig interposed therebetween.

According to aspects of the present disclosure, there is provided a method of manufacturing a secondary battery, which includes seating an electrode assembly on an apparatus for manufacturing a secondary battery including a side pusher formed to press a sub-tab to be welded to an electrode tab of the electrode assembly toward the electrode tab, a first driving module configured to move the side pusher, a support jig installed so that a position thereof is adjustable between the electrode assembly and the side pusher, and a second driving module configured to stop movement of the support jig to restrict movement of the side pusher, a sub-tab holding operation of supporting the sub-tab to be welded to the electrode tab between the support jig and the side pusher, simultaneously moving the side pusher and the support jig toward the electrode assembly to bring the sub-tab into contact with the electrode tab, stopping movement of the support jig in a state in which the sub-tab is in contact with the electrode tab to block a pressing force of the side pusher from being further transmitted to the electrode tab, and welding the sub-tab to the electrode tab.

Aspects and features of the present disclosure are not limited to those described herein, and other aspects and features not specifically mentioned herein will be clearly understood by those skilled in the art from the description of the present disclosure herein.

### BRIEF DESCRIPTION OF THE DRAWINGS

The herein and other objects, features and advantages of the present disclosure will become more apparent to those of ordinary skill in the art by describing exemplary embodiments thereof in detail with reference to the accompanying drawings, in which:

FIG. 1 is a perspective view of a secondary battery manufactured by an apparatus for manufacturing a secondary battery according to some embodiments of the present disclosure;

FIG. 2 is an exploded view illustrating a cap assembly at one side of the secondary battery illustrated in FIG. 1;

FIG. 3 is an exploded perspective view illustrating a current collector separated from an electrode tab of FIG. 2;

FIG. 4 is an exemplary view of a secondary battery module in which secondary batteries manufactured according to some embodiments of the present disclosure are arranged;

FIG. 5 is an exemplary view of a secondary battery pack including the secondary battery module illustrated in FIG. 4;

FIG. 6 is a view illustrating a vehicle including the secondary battery pack illustrated in FIG. 5;

FIG. 7 is an exploded perspective view illustrating a part of the apparatus for manufacturing a secondary battery according to some embodiments of the present disclosure;

FIG. 8 is a view illustrating a sub-tab of FIG. 7 inserted between a support jig and a side pusher;

FIG. 9 is a side view for describing an operation method of the apparatus for manufacturing a secondary battery according to some embodiments of the present disclosure;

FIGS. 10 to 13 are views sequentially illustrating a process of coupling the sub-tab to the electrode assembly;

FIG. 14 is an exploded perspective view illustrating another implementation example of the support jig illustrated in FIG. 7;

FIG. 15 is a view illustrating another implementation example of the side pusher of FIG. 7;

FIG. 16 is a cross-sectional view for describing a method of adjusting a position of a center press illustrated in FIG. 15;

FIGS. 17 and 18 are views for describing a configuration and operation of a part of an apparatus for manufacturing a secondary battery according to embodiments of the present disclosure; and

FIG. 19 is a flowchart illustrating a method of manufacturing a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be narrowly interpreted according to their general or dictionary meanings and should be interpreted as having meanings and concepts that are consistent with the technical idea of the present disclosure on the basis of the principle that an inventor can be his/her own lexicographer to appropriately define concepts of terms to describe his/her disclosure in the best way.

The embodiments described in this specification and the configurations shown in the drawings are only some embodiments of the present disclosure and do not represent all of the aspects, features, and embodiments of the present disclosure. Accordingly, it should be understood that there may be various equivalents and modifications that can replace or modify one or more embodiments or features therein described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed herein could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112() and 35 U.S.C. § 132().

References to two compared elements, features, etc. as being “the same” may mean that they are “substantially the same.” Thus, the phrase “substantially the same” may include a case having a deviation that is considered low in the art, for example, a deviation of 5% or less. In addition, if a certain parameter is referred to as being uniform in a given region, it may mean that it is uniform in terms of an average.

Throughout the specification, unless otherwise stated, each element may be singular or plural. Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

A sub-tab is used as a medium for electrical connection in secondary batteries. The sub-tab includes a current collector and a conductive sheet. The current collector is connected to the electrode tab of a battery cell. In addition, the conductive sheet has a stacking structure and serves to connect the current collector to the terminal. The conductive sheet may be formed of, for example, an aluminum sheet.

The current collector and the electrode tab are bonded by laser welding. However, the conventional laser welding has a disadvantage that the separator inside the electrode assembly can be damaged. The reason why the separator is damaged is that welding heat is transferred to the separator because a distance between the current collector and the electrode assembly is too small. When the separator is damaged, quality problems such as broken insulation of the electrode assembly and the like occur.

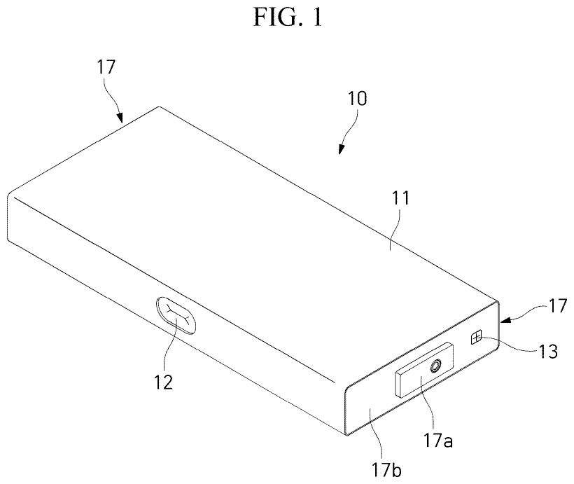

FIG. 1 is a perspective view of a secondary battery manufactured by an apparatus for manufacturing a secondary battery according to some embodiments of the present disclosure. A can 11 may form the overall exterior of a secondary battery and may be made of a conductive metal such as aluminum, an aluminum alloy, or nickel-plated steel. The two ends of the can 11 are open so that an electrode assembly can be accommodated inside.

The cap assembly 17 may include a cap plate 17b covering the open ends of the can 11. A terminal 17a may be installed on both cap assemblies 17. One terminal 17a may be electrically connected to the positive electrode of the electrode assembly inside, and the other terminal may be electrically connected to the negative electrode, and may be installed on the outside of the cap plate 17b. In addition, an electrolyte inlet 13 may be formed on the one cap plate 17b. In addition, a vent 12 for degassing gas generated inside the battery may be installed on one side of the can 11.

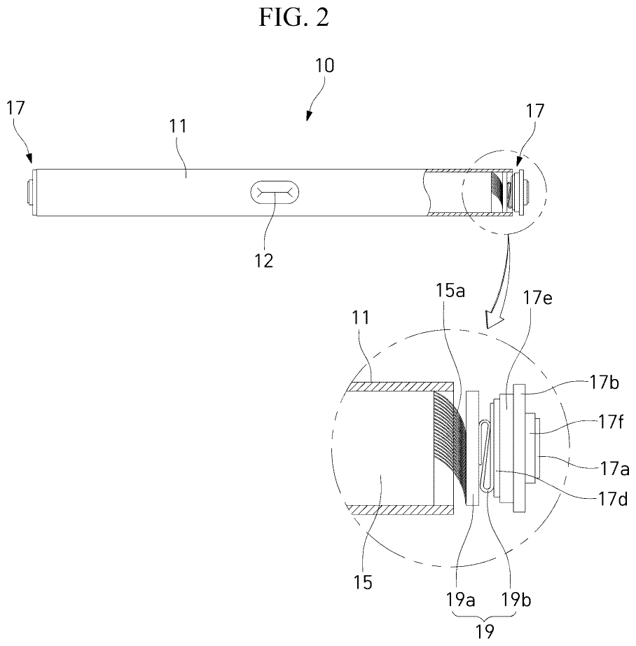

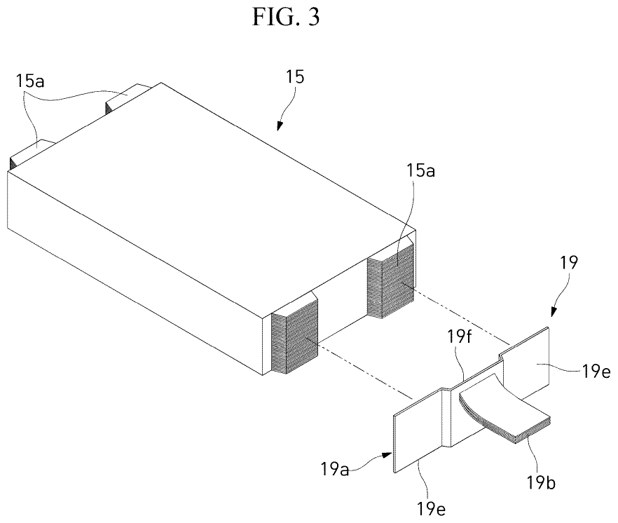

FIG. 2 is an exploded view illustrating a cap assembly 17 at one side of the secondary battery illustrated in FIG. 1, and FIG. 3 is an exploded perspective view illustrating a current collector separated from an electrode tab of FIG. 2.

An electrode assembly 15 inside the can 11 may be formed by winding or stacking a stack of a first electrode plate, a separator, and a second electrode plate, each of which are formed as thin plates or films.

When the electrode assembly 15 is a winding type (i.e., a jelly roll), a winding axis may be parallel to the longitudinal direction of the can 11. In addition, the electrode assembly 15 may be a stack type rather than a winding type. However, the shape of the electrode assembly 15 is not limited in the present disclosure.

In addition, the electrode assembly 15 may be a Z-stack electrode assembly in which a positive electrode plate and a negative electrode plate are inserted into both sides of a separator, which is then bent into a Z-stack. In addition, the electrode assembly 15 may have one or more electrode assembly units stacked and may be accommodated in the can 11, but in the present disclosure, the number of electrode assemblies is not limited thereto. The first electrode plate of the electrode assembly 15 may function as a negative electrode, and the second electrode plate may function as a positive electrode, and vice versa.

The first electrode plate may be formed by having a base substrate made of a metal foil such as copper, a copper alloy, nickel, or a nickel alloy coated with a first electrode active material such as graphite or carbon and may include a first electrode tab (or a first uncoated portion) that is an area in which the first electrode active material is not coated. The first electrode tab can be a passage for current flow between the first electrode plate and one terminal 17a. In some examples, the first electrode tab can be formed by cutting the first electrode plate in advance so that it protrudes toward one side when manufacturing it, and can protrude further toward one side than the separator without separate cutting.

The second electrode plate is formed by having a base substrate made of a metal foil such as aluminum or an aluminum alloy coated with a second electrode active material such as a transition metal oxide and may include a second electrode tab (or a second uncoated portion) that is an area in which the second electrode active material is not coated. The second electrode tab can be a passage for current flow between the second electrode plate and another terminal. In some examples, the second electrode tab may be formed by cutting the second electrode plate in advance to protrude to the other side when the second electrode plate is manufactured and may protrude further to the other side than the separator without separate cutting being performed.

The separator prevents or substantially reduces instances of a short circuit between the first electrode and the second electrode while allowing movement of lithium ions therebetween. The separator may be made of, for example, a polyethylene film, a polypropylene film, a polyethylene-polypropylene film, or the like.

Meanwhile, a sub-tab 19 may be provided on an end portion of the electrode assembly 15. The sub-tab 19 may include a current collector 19a and multilayered conductive sheets 19b. The current collector 19a may be welded to the electrode tab of the electrode assembly 15.

The conductive sheet 19b may be a medium connecting the terminal 17a exposed to the outside to the current collector 19a. The flexible conductive sheet 19b may be bent, and one and the other end portions of the flexible conductive sheet 19b may be fixedly welded to the current collector 19a and the cap assembly 17, respectively.

Since the conductive sheet 19b needs to be flexible and have a current capacity of a predetermined level or higher, the conductive sheet 19b may be formed by stacking multiple thin conductive plates (e.g., aluminum sheets). The bending shape of the conductive sheet 19b is arbitrary and is not limited to that illustrated. The other end portion of the conductive sheet 19b may be welded to a rivet terminal 17d of the cap assembly 17. The rivet terminal 17d may be a part included in the terminal 17a exposed to the outside or connected to the terminal 17a.

The rivet terminal 17d may be insulated from an inner surface of the cap plate 17b by an inner insulator 17e. The sub-tab 19, the rivet terminal 17d, and the inner insulator 17e may be accommodated in the can 11 while positioned inside the cap plate 17b.

A terminal 17a insulated by an external insulator 17f may be positioned on the outside of the cap plate 17b. This terminal 17a may be electrically connected to the inner rivet terminal 17d as mentioned herein. For this electrical connection, a through hole is formed in the terminal 17a, and a connecting pillar (not shown) of the rivet terminal 17d may be inserted into the through hole and riveted. In another embodiment, the terminal 17a located on the outside of the battery and the rivet terminal 17d located on the inside of the battery may be integral.

In order to realize the structure of FIG. 2, a process of inserting an electrode assembly 15 into the interior of a can 11, a process of welding a current collector 19a to an electrode tab of the electrode assembly 15, a process of welding a conductive sheet 19b to a rivet terminal 17d of a cap plate 17b to electrically connect the current collector 19a to an external terminal 17a, and a process of bending a welded sub-tab to attach the cap plate 17b to both openings of the can 11 can be performed.

A structure of the sub-tab 19 will be described in detail with reference to FIG. 3.

The sub-tab 19 may include the current collector 19a and the multilayered conductive sheets 19b. The conductive sheet 19b may be welded to the current collector 19a.

The current collector 19a may be formed by pressing a metal plate having a predetermined thickness and may have a conductive sheet welding part 19f at a central portion thereof and electrode welding parts 19e at both sides thereof. The conductive sheet welding part 19f is a part to which the conductive sheet 19b is welded.

The electrode welding part 19e may be a portion welded to the electrode tab 15a of the electrode assembly 15. When welding heat is applied to the electrode welding part 19e in a state in which the electrode tab 15a is in close contact with the electrode welding part 19e, the electrode welding part 19e may be welded to the electrode tab 15a. However, when the electrode welding part 19e excessively presses the electrode tab 15a, the welding heat may be transferred to an interior of the electrode assembly 15. The object of this application is to solve such a problem, and description thereof will be described herein.

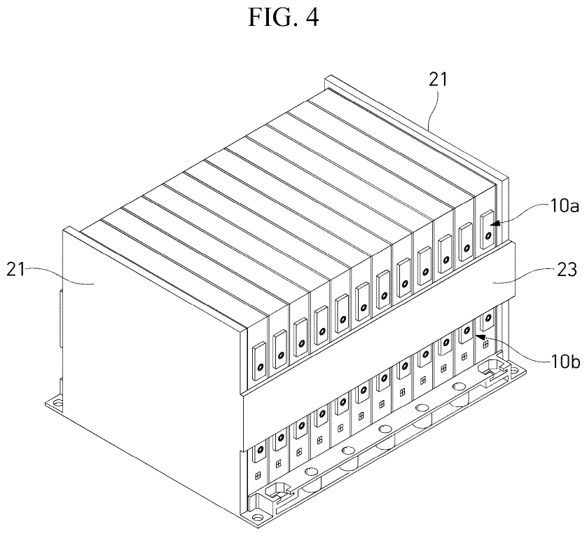

FIG. 4 is an exemplary view of a secondary battery module in which secondary batteries manufactured according to some embodiments of the present disclosure are arranged.

With the high capacity of secondary batteries for driving electric vehicles or the like, a secondary battery module may be manufactured by arranging and connecting a plurality of secondary battery cells in a transverse direction and/or a longitudinal direction. To this end, a plurality of secondary batteries 10 may be arranged horizontally or stacked vertically in a space formed by a pair of opposing end plates 21 and a pair of opposing side plates 23 (10a: second level batteries, 10b: first level batteries). The arrangement of the secondary battery may be designed to have an arrangement direction and number to obtain the desired voltage and current specifications.

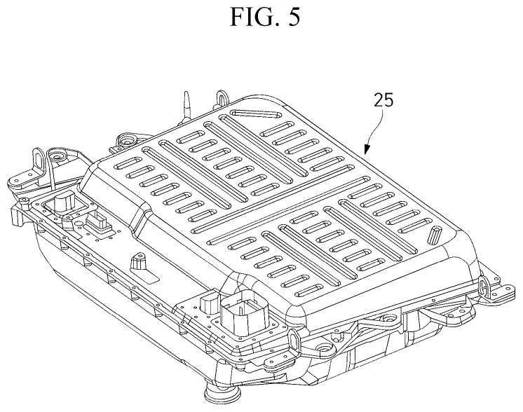

FIG. 5 is an exemplary view of a secondary battery pack including the secondary battery module illustrated in FIG. 4.

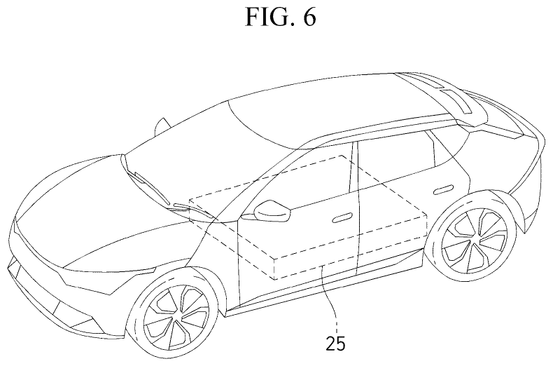

A secondary battery pack can be manufactured by embedding a plurality of secondary battery modules in a pack housing designed to be mounted on an actual product. The pack housing can include fastening portions and electrical outlets necessary for mounting on a product. In FIG. 6, for convenience of illustration, components including a bus bar, a cooling unit, external terminals for electrically connecting batteries, etc., are not shown.

The secondary battery pack may be mounted on a vehicle. The vehicle may be, for example, an electric vehicle, a hybrid vehicle, or a plug-in hybrid vehicle. The vehicle may be a four-wheeled vehicle or a two-wheeled vehicle but is not limited thereto.

FIG. 6 is a view illustrating a vehicle including the secondary battery pack illustrated in FIG. 5.

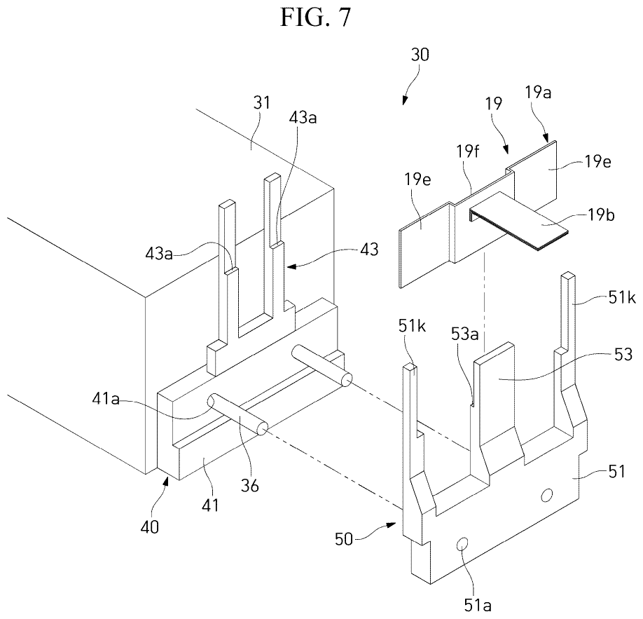

FIG. 7 illustrates that a secondary battery pack 25 according to some embodiments of the present disclosure is mounted on the lower part of a vehicle body. The vehicle operates by receiving power from the secondary battery pack 25 according to some embodiments of the present disclosure.

The materials that can be used in the secondary battery of the present disclosure described herein are described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b>0.5, 0≤c≤0.5, 0≤α≤2); LiₐNi_{1-b-c}Mn_{b}X_{c}O_{2-α}D_{α} (0.90≤a>1.8, 0≤b≤0.5, 0≤c≤0.5, 0<α<2); LiₐNi_{b}Co_{c}L¹GₑO₂ (0.90≤a≤1.8, (9≤b≤0.9, 0≤b≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-g}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the herein formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector (i.e., a substrate) and a positive electrode active material layer formed on the current collector. The positive electrode active material layer may include a positive electrode active material and may further include a binder and/or a conductive material.

The content of the positive electrode active material is in a range of about 90 wt % to about 99 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x≤2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particles and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-Attorney based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, Ceo₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material which are stacked on each other.

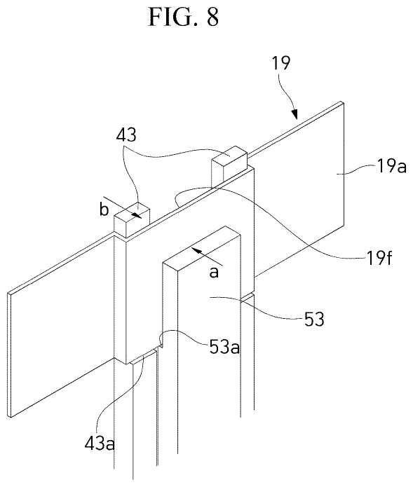

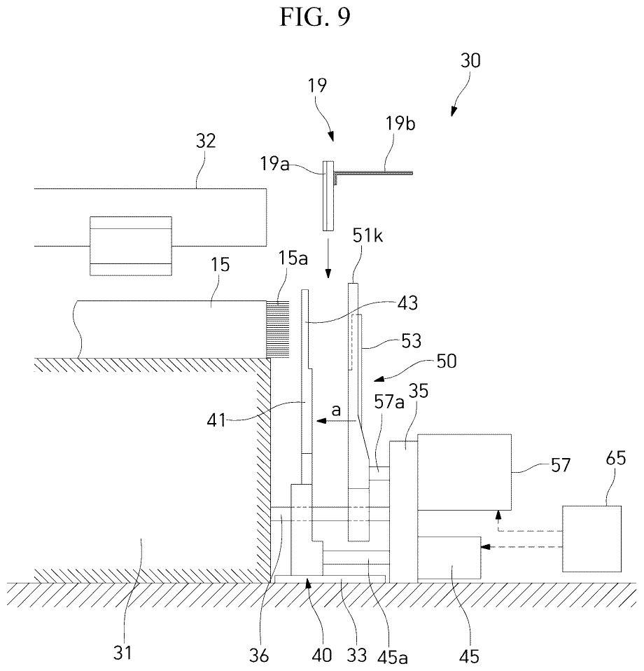

FIG. 7 is an exploded perspective view illustrating a part of the apparatus for manufacturing a secondary battery according to some embodiments of the present disclosure, FIG. 8 is a view illustrating a sub-tab of FIG. 7 inserted between a support jig and a side pusher, and FIG. 9 is a side view for describing an operation method of the apparatus for manufacturing a secondary battery according to some embodiments of the present disclosure.

As illustrated, an apparatus 30 for manufacturing a secondary battery according to the present embodiment may include a support unit 31, a side pusher 50, a first driving module 57, a support jig 40, a second driving module 45, a motion guide, and a gripper 32.

The support unit 31 may support the electrode assembly 15, to which the sub-tab 19 will be welded, to be horizontal. As illustrated in FIG. 9, the electrode assembly 15 supported by the support unit 31 is waiting in a horizontal state, and in this case, the electrode tab 15a protrudes toward the support jig 40.

In addition, the gripper 32 may grip and move the electrode assembly 15. That is, the gripper 32 may position the electrode assembly 15 on the support unit 31 or grip the electrode assembly 15 after welding is completed and take from the support unit 31 out upward. The electrode assembly taken out from the support unit 31 may be transported to a subsequent process line.

The side pusher 50 may be disposed to correspond to the electrode assembly which is waiting on the support unit 31 and may linearly reciprocate in a direction of arrow a and a direction opposite thereto. The linear movement of the side pusher 50 may be implemented by the first driving module 57.

The side pusher 50 may include a main body 51, a center press 53, and an end supporter 51k. The main body 51 is a block-shaped member may reciprocate while being guided by a motion guide and support the center press 53 and the end supporter 51k. Two guide holes 51a are formed in a lower portion of the main body 51. The guide hole 51a may be a passage through which a horizontal rod 36, which is a part of the motion guide, passes.

The center press 53 is a member formed integrally with an upper portion of the main body 51 and may have a support groove 53a in a front surface of the upper end portion thereof. The front surface is a surface facing the electrode assembly 15. As illustrated in FIG. 8, the support groove 53a may support the current collector 19a of the sub-tab 19.

The sub-tab 19 may move toward the electrode assembly 15 while interposed between the center press 53 moving in the direction of arrow a and a slipping prevention part 43 which outputs a reaction force in a direction of arrow b. In addition, the sub-tab 19 may be supported by a catch step 43a of the slipping prevention part 43. That is, the support jig 40 and the side pusher 50 jointly grip the sub-tab 19 while in close contact with each other.

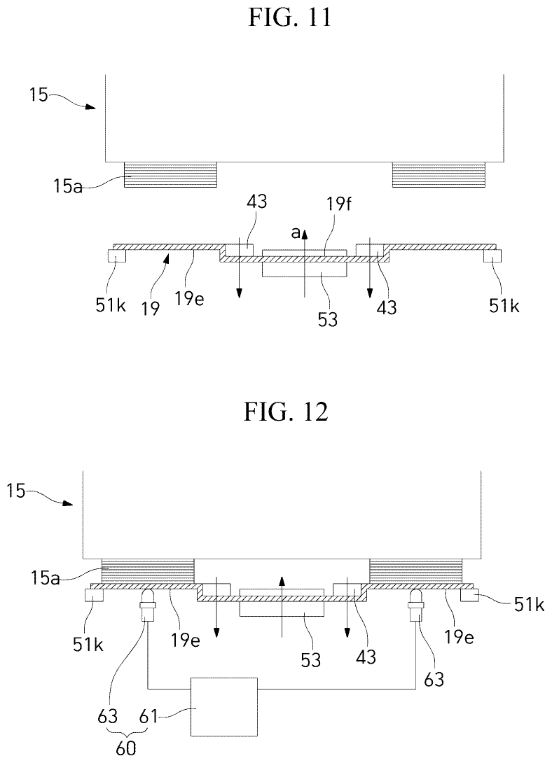

The end supporter 51k may be disposed to be spaced apart from each other at both sides of the center press and support both end portions of the current collector 19a. That is, as illustrated in FIG. 11, the end supporter 51k is in contact with both the end portions of the current collector 19a and supports the current collector 19a forward, that is, toward the electrode assembly 15. The electrode welding part 19e may be in close contact with the electrode tab 15a by the action of the end supporter 51k.

The support jig 40 is a structure which is installed between the support unit 31 and the side pusher 50 so that a position of the support jig 40 may be adjusted. The support jig 40 may include a base 41 and the slipping prevention part 43. The base 41 provides a support force and is guided by the motion guide to enable linear movement. A guide hole 41a through which the horizontal rod 36 passes may be formed in the base 41.

The slipping prevention part 43 may be provided on the base 41, may correspond to the center press 53 with the current collector 19a interposed therebetween, and output a reaction force to a pressing force of the center press. The catch step 43a may be formed on a rear surface of the slipping prevention part 43. The catch step 43a may support the sub-tab 19 as illustrated in FIG. 8.

Meanwhile, the motion guide may guide the linear movement of the side pusher 50 and the support jig 40 with respect to the electrode assembly 15.

The motion guide may include a support structure 35, the horizontal rod 36, and a guide rail 33. The support structure 35 may be a fixed structure fixed to a side opposite to the support unit 31 with the side pusher 50 and the support jig 40 interposed therebetween. The horizontal rod 36 may be a horizontal circular rod connecting the support unit 31 to the support structure 35. Two or more horizontal rods 36 may be disposed parallel to each other and spaced apart from each other and may each pass through the guide hole 41a of the support jig 40 and the guide hole 51a of the side pusher 50. In addition, the guide rail 33 may slidably support a lower end portion of the support jig 40.

The first driving module 57 is connected to the side pusher 50 through a connection shaft 57a while fixed to the support structure 35. The first driving module 57 may allow the side pusher 50 to linearly reciprocate in the direction of arrow a and in the direction opposite thereto. The first driving module 57 may be an electric actuator.

The second driving module 45 is fixed to the support structure 35 and connected to the support jig 40 through a connection shaft 45a. The second driving module 45 may allow the support jig 40 to linearly reciprocate. The second driving module 45 may also be an electric actuator.

The second driving module 45 may stop the support jig 40 in a state in which the sub-tab 19 is in contact with the electrode tab 15a, thereby preventing the support jig from further transmitting the pressing force of the side pusher to the electrode tab. When the support jig 40 is fixed, a forward movement path of the side pusher 50 may be blocked, and thus the side pusher 50 may not continuously move toward the support unit 31. When no support jig 40 is present, the side pusher may continuously move in the direction of arrow a so that the sub-tab 19 may excessively press the electrode tab 15a and damage the separator inside the electrode assembly 15.

The first driving module 57 and the second driving module 45 may be independently controlled by a controller 65. The linear movement of the side pusher 50 and the support jig 40 is performed by the controller 65.

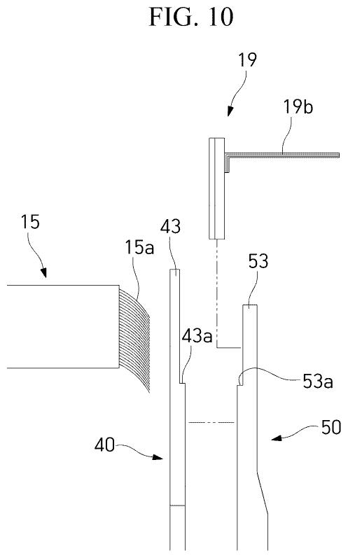

FIGS. 10 to 13 are views sequentially illustrating a process of coupling the sub-tab to the electrode assembly.

FIG. 10 illustrates a waiting state in which the support jig 40 and the side pusher 50 are separated. In such a waiting state, the sub-tab 19 is moved downward to be seated in the support groove 53a so that the side pusher 50 is in close contact with the support jig 40.

FIG. 11 is a plan view illustrating the side pusher 50 and the support jig 40 that are in close contact with each other with the sub-tab 19 interposed therebetween. As illustrated, the center press 53 and the slipping prevention part 43 face each other with the sub-tab 19 interposed therebetween. In addition, the end supporter 51k supports both end portions of the sub-tab 19. In the state of that in FIG. 11, the first and second driving modules 57 and 45 are operated to move an assembly of the side pusher 50 and the support jig 40 toward the electrode assembly 15. Ultimately, when the electrode welding part 19e of the current collector 19a is appropriately in close contact with the electrode tab 15a, the movement of the support jig 40 is stopped. Since the side pusher can no longer move forward in a state in which the support jig 40 is not moved, the pressing action of the sub-tab 19 on the electrode tab 15a may eventually be stopped.

A maximum pressing force of the sub-tab 19 applied to the electrode tab 15a may be adjusted according to the size of the electrode tab 15a and the capacity of the electrode assembly 15.

As described herein, when the sub-tab 19 is completely in close contact with the electrode tab 15a, a welding unit 60 is used to apply welding heat to the electrode welding part 19e. The electrode welding part 19e and the electrode tab 15a may be melted and welded by the welding heat. The welding unit 60 is a laser welder and may include a welder main body 61 and a welding nozzle 63.

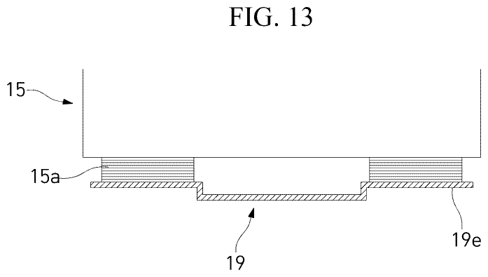

When the herein process is completed, the electrode assembly 15 may be taken out upward using the gripper 32. FIG. 13 illustrates a state in which the sub-tab 19 is welded to the electrode tab 15a.

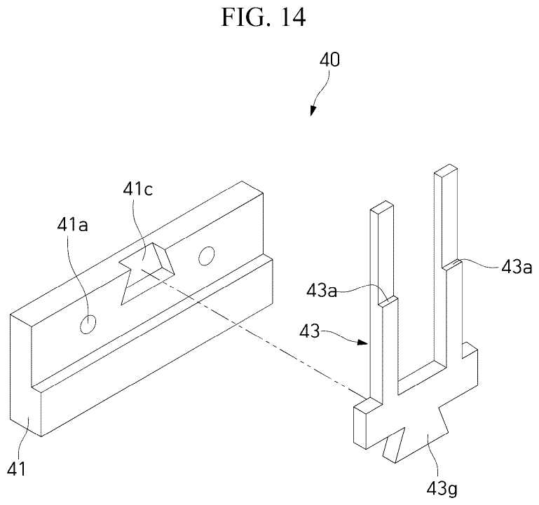

FIG. 14 is an exploded perspective view illustrating another implementation example of the support jig illustrated in FIG. 7.

As illustrated, the base 41 and the slipping prevention part 43 of the support jig 40 may be implemented to be separatable. When the slipping prevention part 43 is detachably formed on the base 41, only the slipping prevention part 43 may be replaced. For example, when slipping prevention parts 43 having various sizes are provided and the size of the sub-tab 19 is changed, the slipping prevention part 43 suitable for the changed sub-tab 19 in size is replaced and used.

To implement the replaceable slipping prevention part 43, a fixing groove 41c may be formed in an upper central portion of the base 41. The fixing groove 41c is a dovetail-shaped groove and is closed forward, that is, toward the support unit 31. The fixing groove 41c is open rearward and upward. In addition, an insertion protrusion 43g is provided on a lower portion of the slipping prevention part 43. The insertion protrusion 43g may be detachably inserted into and coupled to the fixing groove.

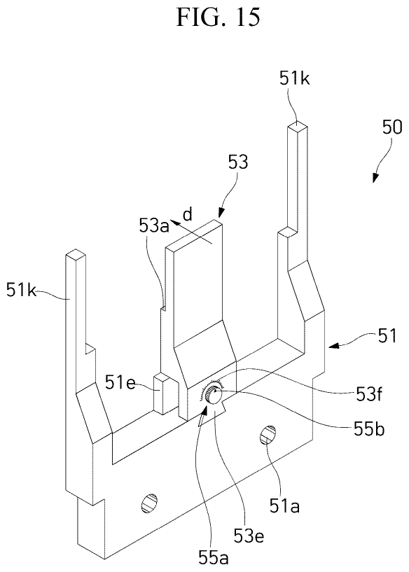

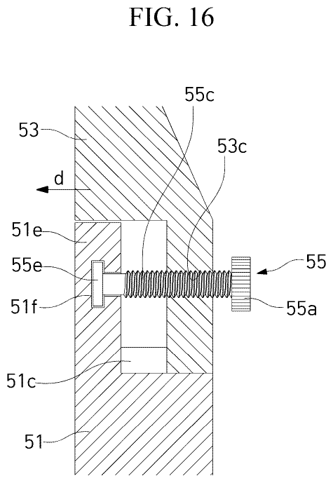

FIG. 15 is a view illustrating another implementation example of the side pusher 50 of FIG. 7, and FIG. 16 is a cross-sectional view for describing a method of adjusting a position of the center press illustrated in FIG. 15.

Meanwhile, as illustrated in FIGS. 15 and 16, the side pusher 50 may be formed in an assembly manner. That is, the center press 53 may be separated from the main body 51 and implemented so that a position thereof is adjustable in a direction of arrow d or a direction opposite thereto.

A guide support groove 51c extending in a direction parallel to a movement direction of the side pusher is formed in the upper portion of the main body.

The center press 53 may be adjusted in position through sliding movement while supported by the guide support groove. The reason for adjusting the position of the center press is to response to a case in which the thickness of the sub-tab 19 changes. When the thickness of the sub-tab 19 increases, the position of the center press 53 may be adjusted rearward, that is, in a direction opposite to the direction of arrow d. In addition, conversely, when the thickness decreases, the center press 53 may be moved in the direction of arrow d.

A support wall part 51e may be further formed on the upper portion of the main body 51. The support wall part 51e may correspond to the guide support groove 51c and have a restriction space 51f therein. The support wall part 51e is a block-shaped member vertically extending to the upper portion of the main body 51. The restriction space 51f may rotatably accommodate a catch disk 55e to be described herein.

In addition, a lower coupling part 53e is provided at a lower side of the center press 53. The lower coupling part 53e may be slidably accommodated in the guide support groove 51c. In addition, a female screw hole 53c may be further formed in the center press. The female screw hole 53c is a horizontal through hole which is colinear with the restriction space 51f. A position adjustment part may be mounted on the female screw hole 53c to rotate in an axial direction.

The position adjustment part 55 serves to adjust the position of the center press 53. That is, the center press 53 may be moved in the direction of arrow d and the direction opposite thereto.

The position adjustment part 55 may include a screw rod 55c, the catch disk 55e, and a knob 55a.

The screw rod 55c is a horizontal male screw rod and may be screw-coupled to the female screw hole 53c. In addition, the catch disk 55e is a disk-shaped member fixed to one end portion of the screw rod 55c and may be rotatably accommodated in the restriction space 51f. When the screw rod 55c rotates axially, the catch disk 55e may be rotated inside the restriction space 51f.

The knob 55a may be a disk-shaped member fixed to the other end portion of the screw rod 55c. The knob 55a is a part which receives a rotational force provided from the outside. When the knob 55a is rotated, the screw rod 55c rotates, and the position of the center press 53 may be adjusted according to the rotation of the screw rod 55c.

In addition, as illustrated in FIG. 15, an index mark 55b is marked on the knob 55a. The index mark 55b serves to indicate a scale part 53f. The scale part 53f is a scale which is marked at an outer side of a main portion of the knob 55a. The position of the center press 53 may be precisely adjusted through the index mark 55b and the scale part 53f.

A distance in a front-rear direction corresponding to a rotation angle of the knob 55a may be marked on the scale part 53f. For example, forward or backward movement of the center press 53 may be displayed in units of millimeters when the knob is rotated by one scale.

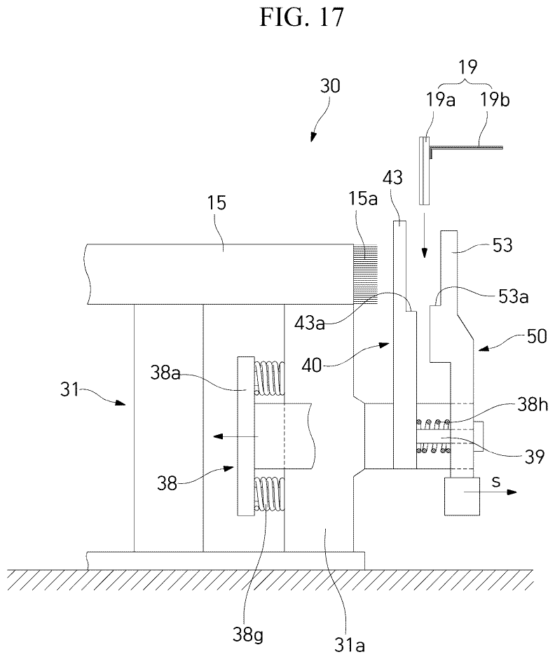

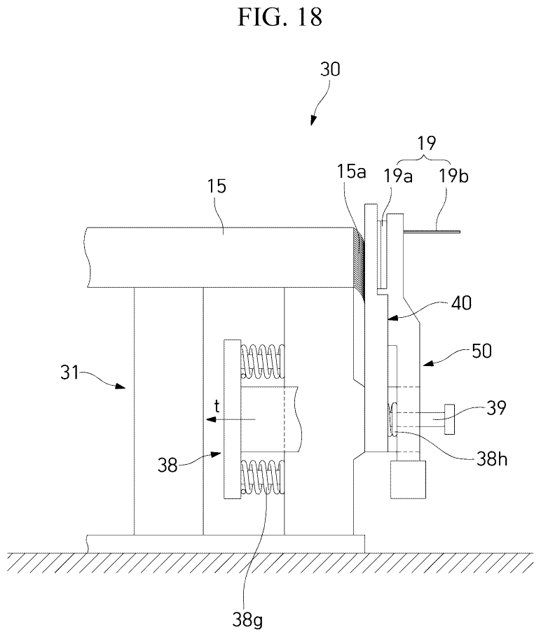

FIGS. 17 and 18 are views for describing a configuration and operation of a part of an apparatus for manufacturing a secondary battery according to embodiments of the present disclosure.

The apparatus 30 for manufacturing a secondary battery illustrated in FIGS. 17 and 18 may include the support unit 31, a reciprocation carrier 38, the side pusher 50, the support jig 40, and an elastic support part.

The support unit 31 illustrated in FIG. 17 has a guide body 31a. The guide body 31a may support the electrode assembly 15 to be horizontal and also reciprocally support the reciprocation carrier 38. The reciprocation carrier 38 may maintain a predetermined height while supported by the guide body 31a and slide in a direction of arrow t of FIG. 18 or a direction opposite thereto.

The reciprocation carrier 38 may have a substantially quadrangular frame-shaped planar structure and accommodate the guide body 31a therein. That is, the guide body 31a is accommodated in the quadrangular frame-shaped reciprocation carrier 38.

The reciprocation carrier 38 may be elastically biased in the direction of arrow t of FIG. 18 by the elastic support part without any external force. The elastic support part elastically supports the reciprocation carrier 38 so that the side pusher 50 elastically presses the sub-tab 19 toward the electrode tab 15a with the support jig 40 interposed therebetween. The elastic support part in the present embodiment may be a first spring 38g. The first spring 38g may be compressed when the side pusher 50 is tensioned in a direction of arrow s of FIG. 17 by an external force. In addition, when the force of tensioning the side pusher 50 is removed, elasticity is restored to move the reciprocation carrier 38 in a direction of arrow t.

The side pusher 50 may be fixed to a right end portion of the reciprocation carrier 38 in the drawing. The side pusher 50 may be formed integrally with the reciprocation carrier 38 and may move along with the reciprocation carrier 38. In addition, the support groove 53a is provided at an upper side of the side pusher 50. The side pusher 50 may elastically press the sub-tab 19 inserted from the outside toward the electrode tab 15a when the reciprocation carrier 38 moves linearly in the direction of arrow t of FIG. 18.

The support jig 40 may be positioned between the support unit 31 and the side pusher 50 while supported in the reciprocation carrier 38. An upper end portion of the support jig 40 is positioned between the electrode assembly 15 and the side pusher 50.

The basic role and object of the support jig 40 are as described with reference to FIGS. 7 to 12. However, there is a difference in that the support jig 40 in FIGS. 17 and 18 provides a reaction force to the side pusher 50 while supported by the guide body 31a.

A guide bolt 39 may be fixed to the support jig 40. The guide bolt 39 may be screw-coupled to the support jig 40 after passing through the side pusher 50. In addition, a second spring 38h may be mounted between the support jig 40 and the side pusher 50. The second spring 38h may elastically support the support jig 40 in a direction away from the side pusher 50 while surrounding the guide bolt 39. The second spring 38h may serve to increase a distance between the support jig and the side pusher when the side pusher 50 is spaced apart from the electrode assembly by an external force, that is, when moving in the direction of arrow s of FIG. 17. As the distance between the support jig 40 and the side pusher 50 increases, the sub-tab 19 may be easily inserted between the support jig 40 and the side pusher 50.

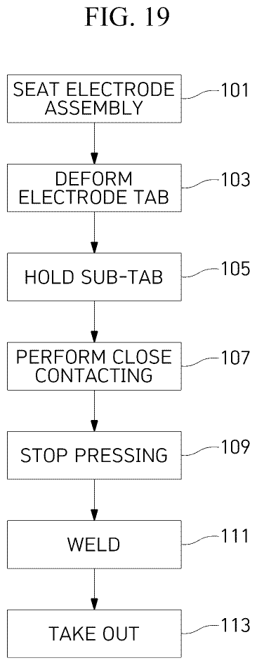

FIG. 19 is a flowchart illustrating a method of manufacturing a secondary battery according to some embodiments of the present disclosure. The method of manufacturing a secondary battery according to the present embodiment is a manufacturing method using the apparatus 30 for manufacturing a secondary battery.

As illustrated, the method of manufacturing a secondary battery according to the present embodiment includes a seating operation 101, an electrode tab deforming operation 103, a sub-tab holding operation 105, a close contacting operation 107, a pressing stop operation 109, a welding operation 111, and a taking-out operation 113.

The seating operation 101 is a process of correctly positioning the electrode assembly 15 on the support unit 31 using a gripper 32. As illustrated in FIG. 9, the electrode tab 15a of the electrode assembly 15 correctly positioned on the support unit 31 is facing the support jig 40. The subsequent electrode tab deforming operation 103 is a process of deforming the electrode tab 15a to expand an area of the electrode tab 15a in contact with the electrode welding part 19e of the sub-tab which will be welded. The deformation of the electrode tab may be implemented, for example, by bending the entirety of the electrode tab 15a upward or downward.

The sub-tab holding operation 105 is a process of supporting the sub-tab, which will be welded to the electrode tab, between the side pusher and the support jig 40. As illustrated in FIG. 8, the sub-tab 19 which has completed the sub-tab holding operation 105 may be interposed between the center press 53 and the slipping prevention part 43.

In addition, the close contacting operation 107 is a process of simultaneously moving the side pusher 50 and the support jig 40 toward the electrode assembly 15 to bring the sub-tab 19 into close contact with the electrode tab 15a. The close contacting operation 107 is performed until the pressing stop operation 109 starts.

The pressing stop operation 109 is a process of stopping the support jig in a state in which the sub-tab is in close contact with the electrode tab to block a pressing force of the side pusher from being further transmitted to the electrode tab. Through the pressing stop operation 109, it is possible to prevent the sub-tab 19 from being excessively in close contact with the electrode tab 15a.

The subsequent welding operation 111 is a process of laser-welding the sub-tab to the electrode tab using the welding unit 60. Through the welding operation 111, the sub-tab 19 may be completely coupled to the electrode tab 15a.

The taking-out operation 113 is a process of vertically lifting the electrode assembly 15 which has completed welding upward using the gripper 32. The taken-out electrode assembly 15 may be transported to a subsequent process line by the gripper.

According to the apparatus and method for manufacturing a secondary battery of the present disclosure, by maintaining a safety distance between a stack of an electrode assembly and a current collector and also securing good adhesion between an electrode tab and the current collector when the current collector is welded to the electrode assembly, it is possible to minimize damage to a separator and increase welding strength.

Although the present disclosure has been described herein with respect to embodiments thereof, the present disclosure is not limited thereto. Various modifications and variations can be made thereto by those skilled in the art within the spirit of the present disclosure as defined by the appended claims and their equivalents.

What is claimed is:

1. An apparatus for manufacturing a secondary battery, comprising:
a side pusher disposed to correspond to an electrode assembly having an electrode tab, and formed to move and press a sub-tab, to be welded to the electrode tab, toward the electrode tab through linear movement;
a first driving module that allows the side pusher to linearly reciprocate;
a support jig installed so that a position thereof is adjustable between the electrode assembly and the side pusher; and
a second driving module configured to stop movement of the support jig while the sub-tab is in contact with the electrode tab and allow the support jig to block a pressing force of the side pusher from being further transmitted to the electrode tab.

2. The apparatus as claimed in claim 1, further comprising:
a support unit formed to support the electrode assembly to be substantially horizontal; and
a motion guide formed to guide linear movement of the side pusher and the support jig with respect to the electrode assembly.

3. The apparatus as claimed in claim 2, wherein the sub-tab comprises:
a current collector that is welded in contact with the electrode tab; and
a metal member coupled to the current collector and formed of a conductive sheet positioned at a side opposite to that of the electrode tab.

4. The apparatus as claimed in claim 3, wherein the side pusher comprises:
a main body guided by the motion guide and configured to reciprocate;
a center press positioned on an upper portion of the main body and formed to press the current collector toward the electrode tab; and
end supporters disposed to be spaced apart from one another at both sides of the center press and support both end portions of the current collector.

5. The apparatus as claimed in claim 4, wherein a support groove for supporting a part of the current collector to prevent sagging of the current collector is formed in the center press.

6. The apparatus as claimed in claim 4, wherein the support jig comprises:
a base formed to provide a support force and guided by the motion guide to linearly move; and
a slipping prevention part that is provided on an upper portion of the base, corresponds to the center press with the current collector interposed therebetween, and outputs a reaction force with respect to a pressing force of the center press.

7. The apparatus as claimed in claim 6, wherein the support jig and the side pusher jointly grip the sub-tab while in contact with one another.

8. The apparatus as claimed in claim 3, further comprising a gripper formed to take the electrode assembly out upward from the support unit after the sub-tab is welded to the electrode tab.

9. The apparatus as claimed in claim 6, wherein the motion guide comprises:
a support structure fixed to a side opposite to the support unit with the side pusher and the support jig interposed therebetween; and
horizontal rods that connect the support unit to the support structure and are substantially parallel to one another.

10. The apparatus as claimed in claim 6, wherein the slipping prevention part is detachably provided on the base.

11. The apparatus as claimed in claim 10, wherein a fixing groove is formed in the base, and
an insertion protrusion detachably coupled to the fixing groove is provided on the slipping prevention part.

12. The apparatus as claimed in claim 4, wherein a position of the center press is adjustable while supported by the main body, and
the side pusher further comprises a position adjustment part for adjusting the position of the center press.

13. The apparatus as claimed in claim 12, wherein a guide support groove extending in a direction substantially parallel to a movement direction of the side pusher is formed in the upper portion of the main body,
the center press slidably moves while supported by the guide support groove, and
the position adjustment part moves the center press along the guide support groove.

14. The apparatus as claimed in claim 13, wherein a support wall part which corresponds to the guide support groove and in which a restriction space is provided is further provided on the upper portion of the main body,
a female screw hole is formed to be substantially colinear with the restriction space in the center press, and
the position adjustment part comprises a screw module which is screw-coupled to the female screw hole, of which one end portion is provided with a catch disk rotatably accommodated in the restriction space, and of which the other end portion has a knob to which an external rotational force is applied.

15. The apparatus as claimed in claim 14, wherein an index mark is marked on the knob, and
a scale part indicated by the index mark is marked on the center press.

16. An apparatus for manufacturing a secondary battery, comprising:
a support unit formed to support an electrode assembly, having an electrode tab, to be horizontal and provide a guide body;
a reciprocation carrier supported by the guide body to reciprocate in a horizontal state by an external force;
a side pusher fixed to the reciprocation carrier and formed to move and support a sub-tab input from an outside of the secondary battery toward the electrode tab by linear motion of the reciprocation carrier;
a support jig positioned between the electrode assembly and the side pusher while supported by the reciprocation carrier; and
an elastic support part that elastically supports the reciprocation carrier and allows the side pusher to elastically press the sub-tab toward the electrode tab with the support jig interposed therebetween.

17. The apparatus as claimed in claim 16, wherein a spring formed to increase a distance between the support jig and the side pusher when the side pusher is spaced apart from the electrode assembly by the external force is formed between the side pusher and the support jig.

18. A method of manufacturing a secondary battery, comprising:
seating an electrode assembly on an apparatus for manufacturing a secondary battery that comprises a side pusher formed to press a sub-tab, to be welded to an electrode tab of the electrode assembly, toward the electrode tab, a first driving module configured to move the side pusher, a support jig installed so that a position thereof is adjustable between the electrode assembly and the side pusher, and a second driving module configured to stop movement of the support jig to restrict movement of the side pusher;
supporting the sub-tab to be welded to the electrode tab between the support jig and the side pusher;
simultaneously moving the side pusher and the support jig toward the electrode assembly to bring the sub-tab into contact with the electrode tab;
stopping movement of the support jig in a state in which the sub-tab is in contact with the electrode tab to block a pressing force of the side pusher from being further transmitted to the electrode tab; and
welding the sub-tab to the electrode tab.

19. The method as claimed in claim 18, further comprising deforming the electrode tab and expanding an area of the electrode tab in contact with the sub-tab.

20. The method as claimed in claim 18, wherein the welding is laser welding.
